(19) United States
(12) Patent Application Publication
(10) Pub. No.: US 2004/0153012 A1
(43) Pub. Date: Aug. 5, 2004

(54) Press and roll massage vest

(76) Inventor: Kathryn G. Schroeder, Onalaska, WI (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/643,058

(22) Filed: Aug. 18, 2003

Related U.S. Application Data
(60) Provisional application No. 60/404,270, filed on Aug. 19, 2002.

(51) Int. Cl. A61H 1/00

(52) U.S. Cl. 601/19

(57) ABSTRACT

A sleeveless garment, namely a vest, in which the back of the garment and lining are sewn together in a manner that creates a series of horizontal compartments or channels, one above the other, from the bottom to the top of the garment. The garment size varies based upon the size of the user. The garment further contains pockets to store therapeutic massage tools during periods of non-use. The number of horizontal compartments or channels is based upon the size of the garment, etc, but are chosen to cover a majority of the user's backs. Therapeutic massage tools are placed in one or more of the horizontal compartments or channels from the inside of the back of the garment. Therapeutic massage tools may be placed in the horizontal compartments or channels that align with the location on the user's back where the user is experiencing pain or discomfort. Therapeutic massage tools may vary in type, size and consistency depending on the user's preference. The garment is then worn by the user with the horizontal compartments or channels to the back. The user then places his or her back against a firm surface with the therapeutic massage tools compressed between their back and the firm surface. The user then manipulates, rolls and moves the therapeutic massage tool by pressing against the firm surface and moving in various directions, up, down, right, left, and diagonally. In this manner, the user may massage desired areas providing specific, self-automated relief via the massaging effect of the massage therapy garment.

### CROSS REFERENCE TO RELATED APPLICATIONS

This invention is related to the invention described in the provisional application serial No. 60/404,270 filed on Aug. 19, 2002, and claims priority therefrom.

### BACKGROUND OF THE INVENTION

1. Field of the Invention

This invention relates generally to a device used for massage therapy. In particular, this invention relates to a massage garment containing horizontal compartments or channels in the back of the vest in which various therapeutic massage tools may be used for massage therapy. Further, the garment includes a number of storage pockets inside the front portion for storage of the massage tools when not in use.

2. Description of the Related Art

Muscle stiffness and muscle pain can be generated from numerous sources including fatigue, stress, over exertion, etc. These conditions typically are non-life-threatening and more often simply result in discomfort and occasionally short-term pain. One method of treating this pain or stiffness is through the use of massage techniques. The art of massage is known to be effective in therapeutic treatment to relieve pain, tension, and fatigue because of its stimulating effect on the circulatory system, muscles, and joints.

Unfortunately, it is unrealistic to find massage assistance every time stiffness or soreness occurs. Obviously it is relieving and beneficial if a massage therapist can be found. However, in most cases this is unrealistic for the common individual. Consequently, it is much more desirable to have some type of device whereby a user can provide focused massaging of sore or strained muscles in order achieve temporary relief of the pain involved.

There are a variety of inventions related to massage therapy. Specifically, U.S. Pat. No. 5,381,558 issued to Lo in 1995 discloses a massage garment with protuberances sown into the garment. Next, U.S. Pat. No. 5,779,652 issued to Mencher-Aliazzo in 1998 discloses a twine or denier massage device with spherical balls that are slide able so that the user can configure the balls as desired and then apply pressure to the massage device from the floor, bed, seat, or wall. Finally, U.S. Pat. No. 5,978,965 issued to Summers in 1999, discloses an upper body garment with massaging pads that contain modules where the pads are inserted in strips of pockets in the garment along the neck, back lower back areas in a convex, curved profile for massaging and stretching. However none of these inventions allow users to position a desired quantity of therapeutic massage tools in virtually any position for treatment of specific areas. Further, none of these inventions disclose the option of choosing different massage tools for use in a massage garment. Finally, none of these inventions disclose the inclusion of storage compartment for unused massage tools within a massage garment.

While there are various massage therapy devices currently available, there exists the need for a massage therapy device that is conveniently and easily used and does not require additional storage or carrying locations. In addition, a need exists for a back and neck massage apparatus that provides positioning of therapeutic massage tools in any location. A need exists for a massage garment for which the user may choose the type, size and consistency of the massage tool to be placed in the garment compartments or channels depending on the user's therapeutic need. A further need exists for a massage therapy device that allows users to position as many therapeutic massage tools as necessary in a plurality of positions to obtain transverse massaging of back and neck muscles.

### BRIEF SUMMARY OF THE INVENTION

These needs are met by the construction and massage technique employed in the present invention. It is an object of the present invention that users may easily provide massage techniques to sore and stiff areas of the body at any time. In order to do so, the user may choose the type, size, and consistency of therapeutic massage tools for use in compartments or channels oriented in a horizontal fashion across the back and neck portion of a massage garment. Users may place as many therapeutic massage tools as necessary at a plurality of locations within the horizontal compartments channels in the massage garment. Users may then wear the garment while applying pressure by placing their backs against a firm surface. This allows for the easy manipulation of the therapeutic massage tools and vest to massage areas of pain or discomfort. In this manner, users may provide specific, self-automated relief to various types of muscle stiffness and pressure point pain via the massaging effect of the massage therapy garment.

It is a further objective of this invention that users may store unused therapeutic massage tools in two pockets located inside the front portion of the massage garment. These pockets are designed to hold several therapeutic massage tools of various sizes and shapes when not in use. In this manner, users may carry with them several different type, size, and consistency of therapeutic massage tools for enhanced convenience and mobility of the overall massage therapy garment.

As referenced above, the massage vest of the present invention is a worn garment, which includes the plurality of horizontal compartments positioned throughout. Each of these compartments is configured to house the desired massage tools, while also allowing their easy insertion and removal. The compartments exist across the entire back of the garment, thus allowing for specific placement at virtually any location of the users back.

While the garment is specifically referenced as a vest, and will be illustrated as such below, the invention encompasses virtually any garment, which includes the desired channels. By this configuration, a massage tool is likewise positionable in a jacket or other garment type.

### BRIEF DESCRIPTION OF THE DRAWINGS

FIG. 1 depicts the front of a massage garment showing the outline of two interior pockets in which therapeutic massage tools may be stored when not in use.

FIG. 2 depicts the back of a massage garment several with horizontal pockets stacked above one another and used to massage specific areas of the wearer's back and neck.

FIG. 3 depicts the inside of a massage garment showing the interior pockets and plurality of channels.

FIG. 4 illustrates the application of pressure to the back of a massage garment once therapeutic massage tools have been inserted in the back pockets of the garment as necessary to massage the areas of pain or discomfort.

### DETAILED DESCRIPTION OF THE INVENTION

The present invention relates to massage garment containing pockets and compartments on both the front and on the rear of the vest, respectively. In particular, the front pockets are used to store therapeutic massage tools when not in use, while several horizontal compartments or channels stacked above one another are arranged on the back of the garment. These back compartments are capable of holding the therapeutic massage tools thus allowing the user to massage specific areas of his or her back. For instance, a therapeutic massage tool, such as a ball, is placed in a selected pocket from the inside of the back of the vest based on the location of the user's pain or discomfort. The user then places his or her back against a firm surface so that the therapeutic massage tool is compressed between the firm surface and the user's back. The user then manipulates the therapeutic massage tools and vest to massage the desired areas. The user may choose the type of therapeutic massage tool (34), depending on the user's therapeutic needs. One particular example of a suitable therapeutic massage tool is a hollow ball that may vary in size and consistency.

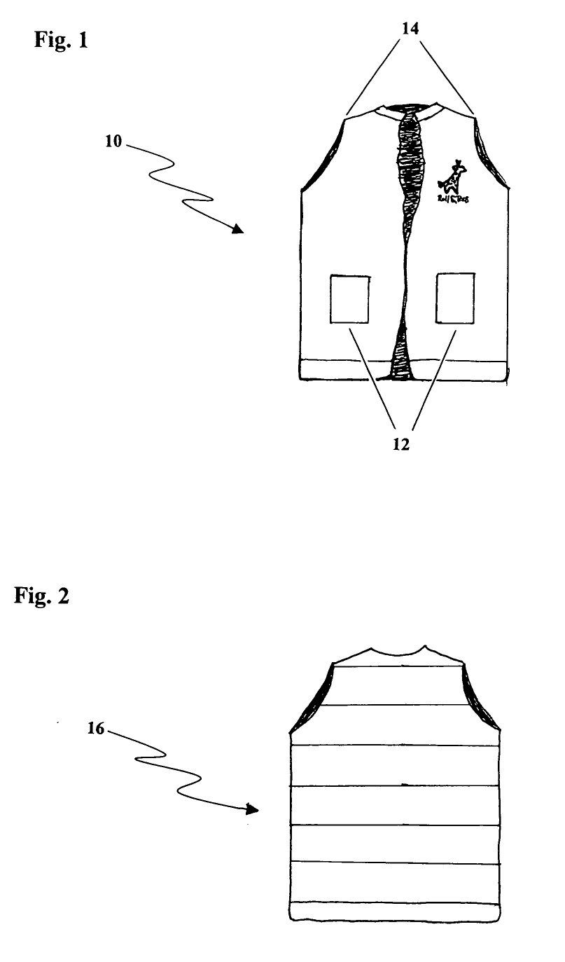

Referring to FIG. 1, the front (10) of a massage garment is shown. This particular embodiment of the garment is sleeveless, namely a vest. The user wears the vest by placing his/her arms through two, sleeveless arm openings (14). The size of the garment varies with the size of the user. The front (10) of the massage garment also has two interior pockets (12). The front interior pockets (12) provide convenient storage for the therapeutic massage tools (34) when the massage garment is not in use.

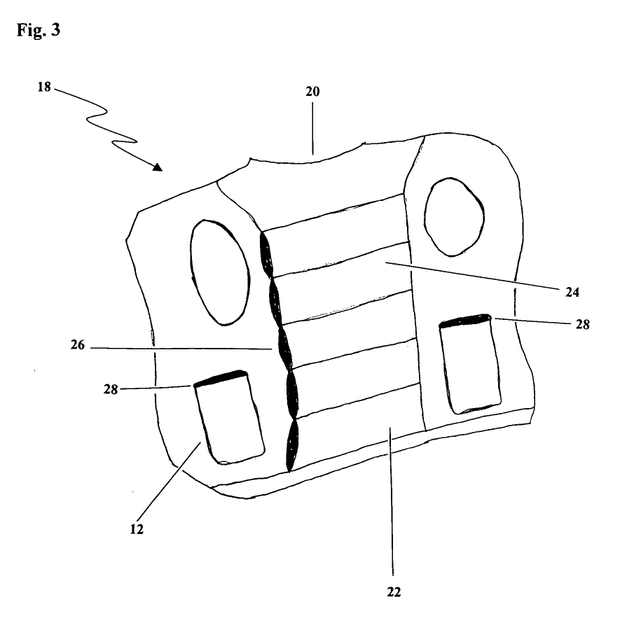

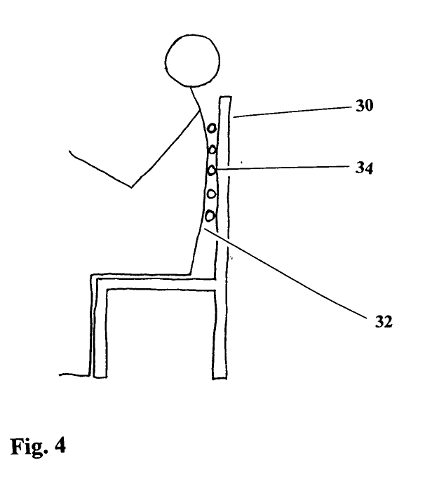

Referring to FIG. 2, the back (16) of a massage garment is shown. Referring to FIG. 3, the inside (18) of a massage garment is shown. The inside back (20) of the massage garment has a smooth sateen, inner lining (22). The back (16) of the massage garment and the inner lining (22) are sown together in a manner that creates a series of horizontal compartments, or channels (24) one above the other, from the top to the bottom of the massage garment. These horizontal compartments, or channels, (24) are three to four inches in height and extend the entire width of the back (16) of the massage garment.

Referring to FIG. 3, any desired number of therapeutic massage tools (34), preferably hollow rubber therapeutic balls, may be placed in one or more of the horizontal compartments, or channels (24). The therapeutic massage tools (34) may vary in size, shape and consistency. One example of a common type massage tool (34) is a compressible ball of some type, such as a racquetball, tennis ball, etc. Alternatively, the massage tool may be solid, such as a wooden ball. The user may align the placement of the massage tool at the horizontal compartment, or channel, (24) that aligns with the location on the user's back where the user is experiencing pain or discomfort. The user may position a number of therapeutic massage tools (34) in a plurality of locations to provide several degrees of motion during massage therapy. Any desired quantity of therapeutic massage tools (34) may be placed in the horizontal compartment, or channel, (24) via the openings (26) sown between the back (16) of the massage garment and the inner lining (22). The openings (26) are accessed from the inside (18) of the massage garment. In addition, unused therapeutic massage tools (34) may be placed in the front interior pockets (12) of the massage garment via the pocket openings (28) accessed in the inside (18) of the massage garment.

Referring to FIG. 4, the user may wear the massage garment with the therapeutic massage tools (34) in the horizontal compartment, or channels, (24) in the back (16) of the massage garment. The user may then place his or her back against a firm surface (30), such as a wall, chair back, or the floor. The therapeutic massage tools (34) are compressed between the user's back (32) and the firm surface (30), pressing on a certain pressure point or moving in various directions, including up, down, right, left, and diagonally. In this manner, the user may massage the desired areas and provide specific, self-automated relief to various types of muscle stiffness and pressure point pain via the transverse massaging effect of the massage therapy garment.

The foregoing detailed description of the preferred embodiments of the invention has been provided for the purposes of illustration and description. It is not intended to be exhaustive or to limit the invention to the precise embodiments disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A device for massaging the anatomy of a body part, said device comprising:
a garment configured for wear by a user;
a plurality horizontal compartments or channels located from the top to the bottom of the back of said garment in which various therapeutic massage tools may be placed; and
interior pockets located in the front interior of said garment.

2. The device according to claim 1 wherein said therapeutic massage tools may be stored in the interior pockets located in the front of said garment.

3. The device according to claim 1 wherein said therapeutic massage tools may be various shapes, sizes and consistencies.

4. The device according to claim 1 wherein said therapeutic massage tools may be hollow balls with varying sizes and consistencies.

5. A massage therapy garment for use by a user to provide massage treatment to localized soreness and stiffness at an identified area of the user's body, the garment comprising:
a garment body configured to be worn by the user and configured to cover the identified area;
a plurality of adjacent and substantially horizontal chambers formed by layers of the garment body, each chamber configured to house at least one massage tool, the plurality of chambers covering a majority of the user's body in order to provide placement of the at least one massage tool at the identified area; and
a storage compartment attached to the garment body for storing the at least one massage tool when not in use.

6. The massage therapy device of claim 6 wherein the garment is a vest.

7. The massage therapy device of claim 6 wherein the garment is a jacket.

8. The massage therapy device of claim 6 wherein the massage tool is a compressible ball.

9. The massage therapy device of claim 9 wherein the compressible ball is a racquetball.

10. The massage therapy device of claim 9 wherein the compressible ball is a tennis ball.

11. The massage therapy device of claim 6 wherein the channels are formed from a first garment layer and a second garment layer which are joined to one-another with a plurality of parallel seams.

12. The massage therapy device of claim 6 wherein the massage tool is a solid ball.

13. The massage therapy device of claim 6 wherein the identified location is in the user's back.

14. The massage therapy device of claim 6 wherein the identified location is in the user's lower neck.
